(19) United States
(12) Patent Application Publication
(10) Pub. No.: US 2025/0103355 A1
(43) Pub. Date: Mar. 27, 2025

(54) VIDEO INJECTION SYSTEM

(71) Applicant: BrowserStack Limited, Dublin (IE)

(72) Inventors: Jimesh Chokshi, Mumbai (IN); Darpan Lalwani, Mumbai (IN); Harshit Biren Shah, Mumbai (IN); Sourabh Gome, Ujjain (IN)

(21) Appl. No.: 18/373,507

(22) Filed: Sep. 27, 2023

(51) Int. Cl. G06F 9/445; H04L 67/02; H04L 67/56

(52) U.S. Cl. CPC G06F 9/44526; H04L 67/02; H04L 67/56

(57) ABSTRACT

A video injection system comprises a user browser, a remote device, and a proxy layer. The user browser is installed on a user device and is used to log-in and connect to a cloud server that comprises representations of the remote devices. The user browser is used to remotely connect to a remote device, where the remote device uses a remote device's browser to access a website using a network call, which retrieves a web-page response associated with the website. The proxy layer present in the cloud server intercepts the retrieved web-page response and injects a java-script into the retrieved web-page response. When the user accesses a camera of the remote device via the remote device's browser, the injected java-script injects a video sample that was uploaded on a storage platform to the web page response, where the injected video sample is captured by the camera of the remote device.

### TECHNICAL FIELD

The present invention relates to a field of testing of remote devices, more specifically, a system and an associated method that provides a video viewing solution to a tester who is testing the camera of a remotely positioned real device.

### BACKGROUND

Background description includes information that may be useful in understanding the present invention. It is not an admission that any of the information provided herein is prior art or relevant to the presently disclosed invention, or that any publication specifically or implicitly referenced is prior art.

Testing websites on devices is a specialized task that is practiced by individual testers, companies that are involved in website development, mobile application designing, research and development teams involved in designing software applications, etc. Currently, to assist such testing programs, there are products that provide an infrastructure with remote devices. These remote devices are for example, mobile phones (Android©/iOS©) or desktops. Testers use this infrastructure to test their websites across a variety of Device-OS combinations. These tests include functionality testing, look and feel of the website, etc. This infrastructure can be accessed by the testers from their respective laptops/desktops by accessing the internet.

In this context, testing of camera use cases play a vital role with websites which have heavy functionalities based on camera of the device. If the tester is testing a camera functionality with a non-remote device, they can simply open the website, click on the camera button and the camera hardware will start capturing the objects in front of the camera onto the screen of the device like a live video. However, if the same video functionality needs to be tested on different Device-OS combinations, the testers need a remote testing infrastructure. However, these devices are placed in a different location geographically. Therefore, testers are looking for solutions to test the camera functionality on the websites onto remote infrastructure.

In an example scenario, a tester wants to test how the home page of a website works on different devices. Initially, the tester logs into the remote platform. A server in connection with the platform assigns a real device to the tester, where the device is positioned remotely. This way the actual device screen is streamed in front of the tester on laptop/desktop screen, and the tester is enabled to access and interact with the real device, for example, in a remotely controlled mode or a screen shared mode. The tester will then open the website on the browser of the real device that is being remotely shared on his/her laptop/desktop. When the tester clicks on the camera option through the website, the home page starts accessing the camera of the remotely positioned real device. In case, if the real device is placed in a position where the camera is unable to view anything meaningful, for example, the real device being placed on a rack, then the website won't be able to capture the video correctly.

Therefore, there is a need for a system and an associated method that provides a video viewing solution to the tester while testing the camera of a remotely positioned real device.

### SUMMARY OF THE INVENTION

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

As used herein:
The term “remote device” refers to, for example, mobile phones (Android©/iOS©) or desktops.
The term “user browser” refers to the browser that is available on the user's laptop/desktop, that the tester uses to access a remote device from a server.
The term “proxy layer” refers to any application that functions as a proxy for the requests placed from a client computer in association with the protocols of any application.
The term “remote device's browser” refers to a browser that is installed on the remote device that is available on the server.
The term “web-page response” refers to, for example, an HTTP response that is performed by a server to a client. The intent of the response is to deliver to the client with the means it requested or notify the client that the function that it requested has been executed. In the contrary, the response informs the client that an error has happened during processing of the request.

A video injection system and an associated method to test websites across multiple remote devices disclosed here addresses the above-mentioned need for a video viewing solution to the tester while testing a website that uses the camera of a remotely positioned real device. The video injection system comprises of a user browser, a remote device, and a proxy layer. The user browser is used to log-in and connect to a cloud server that comprises representations of the remote devices. The user browser is used to remotely connect to a remote device from the list of the remote devices available on the cloud server. The remote device uses a remote device's browser to access a website by performing a network call, which retrieves a web-page response associated with the website. The proxy layer present in the cloud server intercepts the retrieved web-page response and injects a java-script into the retrieved web-page response. When the user accesses the camera of the remote device via the remote device's browser, the injected java-script injects a video sample that was uploaded on a storage platform to the web page response, so that the injected video sample is captured by the camera of the remote device.

In an embodiment, the cloud server assigns a remote device from the plurality of remote devices, wherein the cloud server streams the selected device to the user browser so that the user is enabled to view an actual screen of the selected device on the user browser. In an embodiment, the video injection system further comprises multiple video samples that are uploaded on the storage platform that is in communication with the cloud server. The injected java-script retrieves one of the uploaded video samples from the storage platform and injects the video sample on the remote device's browser when the user accesses the camera of the remote device.

In an embodiment, when the network call is made to load the website, the website sends the web-page response which contains web components associated with the website. Now, when the web-page response reaches the proxy layer, the java-script is injected into the web-page response which becomes a part of the user's web-page source. In an embodiment, once the website loads, and each time the camera is accessed, a call is made to a system function, which is intercepted by the injected java-script to stream one of the uploaded video samples instead of direct video stream from the camera of the remote device and supplies the stream to the website as output of the camera.

In an embodiment, the proxy layer that modifies the web page response received by the remote device's browser alters: 1) the Content-Security-Policies that are set in plurality of response headers to allow the injected java-script to be loaded on the website; and 2) the Cross-origin resource sharing (CORS) policy that is set in the multiple response headers of the web-page response, to enable loading of the uploaded video samples from the storage platform that is not whitelisted on the website under test. In an embodiment, the proxy layer that modifies the web page response received by the remote device's browser: 1) converts streaming of the uploaded video sample via the injected java-script into a media stream object; 2) creates a video object from the streamed uploaded video sample, which is played into a canvas object; and 3) generates a media stream object from the canvas object.

In an embodiment, a method to test websites across multiple remote devices comprises: 1) providing a user browser installed on a user device that is controlled by at least one processor; 2) logging in to a cloud server via the user browser, and the cloud server comprises representations of multiple remote devices; 3) remotely connecting to a remote device on the cloud server using the user browser; 4) accessing a website by performing a network call via a remote device's browser of the remote device, which retrieves a web-page response associated with the website; 5) intercepting the retrieved web-page response via a proxy layer present in the cloud server; 6) injecting a java-script into the retrieved web-page response via the proxy layer; 7) injecting, via the injected java-script, a video sample that was uploaded on a storage platform to the web page response when the user accesses a camera of the remote device via the remote device's browser; and 8) capturing the injected video sample by the camera of the remote device and playing the video.

These and other objects, embodiments and advantages of the present invention will become readily apparent to those skilled in the art from the following detailed description of the embodiments having reference to the attached figures, the invention not being limited to any particular embodiments disclosed.

### BRIEF DESCRIPTION OF FIGURES

The foregoing and further objects, features and advantages of the present subject matter will become apparent from the following description of exemplary embodiments with reference to the accompanying drawings, wherein like numerals are used to represent like elements.

It is to be noted, however, that the appended drawings along with the reference numerals illustrate only typical embodiments of the present subject matter, and are therefore, not to be considered for limiting its scope, for the subject matter may admit to other equally effective embodiments.

FIG. 1 exemplarily illustrates a video injection system to test websites across multiple remote devices, as an example embodiment of the present disclosure.

FIG. 2 exemplarily illustrates a method flow diagram associated with the video injection system to test websites across multiple remote devices, as an example embodiment of the present disclosure.

FIG. 3A exemplarily illustrates a flowchart associated with the method followed in the video injection system to test websites across multiple remote devices, as an example embodiment of the present disclosure.

FIG. 3B illustrates a block diagram of the modified website testing procedure using the video injection system, which tests a website across multiple remote devices, as an example embodiment of the present disclosure.

FIG. 4 is a block diagram that illustrates a computer system upon which embodiments of the video injection system can be implemented.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

It is to be noted, however, that the reference numerals used herein illustrate only typical embodiments of the present subject matter, and are therefore, not to be considered for limiting its scope, for the subject matter may admit to other equally effective embodiments.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skills in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown.

The connections shown are logical connections; the actual physical connections may be different. It is apparent to a person skilled in the art that the structure may also comprise other functions and structures.

Also, all logical units described and depicted in the figures include the software and/or hardware components required for the unit to function. Further, each unit may comprise within itself one or more components which are implicitly understood. These components may be operatively coupled to each other and be configured to communicate with each other to perform the function of the said unit.

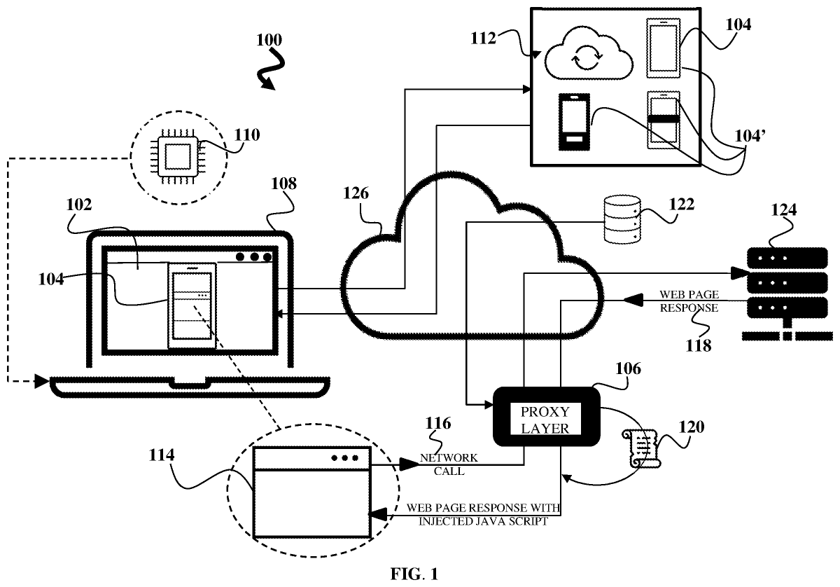

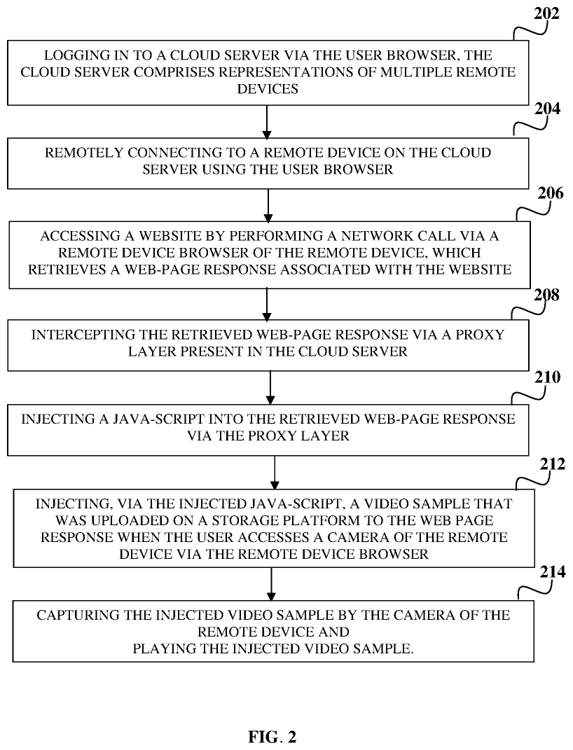

Referring to FIGS. 1 and 2, FIG. 1 exemplarily illustrates a video injection system 100 to test websites across multiple remote devices 104, as an example embodiment of the present disclosure. FIG. 2 exemplarily illustrates a method flow diagram associated with the video injection system 100 to test websites across multiple remote devices 104, as an example embodiment of the present disclosure. A video injection system 100 to test websites across multiple remote devices 104 comprise a user browser 102, a remote device 104, and a proxy layer 106. The user browser 102 is installed on a user device 108 that is controlled by at least one processor 110, and the user browser 102 is used to log-in 202 (FIG. 2) and connect to a cloud server 112 that comprises representations of the remote devices 104. The user browser 102 is used to remotely connect 204 (FIG. 2) to a remote device 104, via a communication network 126, from the list of the remote devices 104′ available on the cloud server 112.

The remote device 104 uses a remote device's browser 114 to access 206 (FIG. 2) a website via the communication network 126, by performing a network call 116 to a web server 124, which retrieves a web-page response 118 associated with the website. The proxy layer 106 present in the cloud server 112 intercepts 208 (FIG. 2) the retrieved web-page response 118 and injects 210 (FIG. 2) a java-script 120 into the retrieved web-page response 118. Every website loads through a network call 116, which can be manipulated or intercepted before loading on the user browser 102, which is performed by the proxy layer 106 a network level.

When the user accesses a camera of the remote device 104 via the remote device's browser 114, the injected java-script 120 injects 212 (FIG. 2) a video sample that was uploaded on a storage platform 122 to the web-page response 118, so that the injected video sample is captured by the camera of the (FIG. 2) remote device 104. In other words, the injected video sample mocks the behavior of the camera of the remote device 104. In an example, the video sample is uploaded to the storage platform 122 via an endpoint, for example, desktop, laptop, mobile phones, etc. The cloud server 112 assigns a remote device 104 from the plurality of remote devices 104′, wherein the cloud server 112 streams the selected device to the user browser 102 so that the user is enabled to view an actual screen of the selected device on the user browser 102.

The video injection system 100 further comprises multiple video samples that are uploaded on the storage platform 122 that is in communication with the cloud server 112. The injected java-script 120 retrieves one of the uploaded video samples from the storage platform 122 and injects the video sample on the remote device's browser 114 when the user accesses the camera of the remote device 104. When the network call 116 is made to load the website, the website sends the web-page response 118 which contains web components, associated with the website. The web components are, for example, a JavaScript(R) function, a collection of JavaScript(R) code, a collection of CSS lines, an image, or the like. Now, when the web-page response 118 reaches the proxy layer 106, the java-script 120 is injected into the web-page response 118 which becomes a part of the user's web-page source.

Once the website loads, and each time the camera is accessed, a call is made to a system function, which is intercepted by the injected java-script 120 to stream one of the uploaded video samples instead of direct video stream from the camera of the remote device 104 and supplies the stream to the website as output of the camera. Here, the injected java-script 120 is responsible for injecting the pre-fed video sample whenever the camera of the remote device 104 is accessed for taking a video. As used herein, the purpose of the injected java-script 120: once the website loads, and each time the camera is called, there is a call made to getUserMedia( ) which is a system method, which returns a promise of the media stream. This function is responsible for streaming the videos from the camera and supplying the stream to the user's website as camera's output. This method can be mocked to return user uploaded (pre-loaded custom video) instead of streaming from the camera hardware of the remote device 104. Mocking of this function is done through the injected java-script 120.

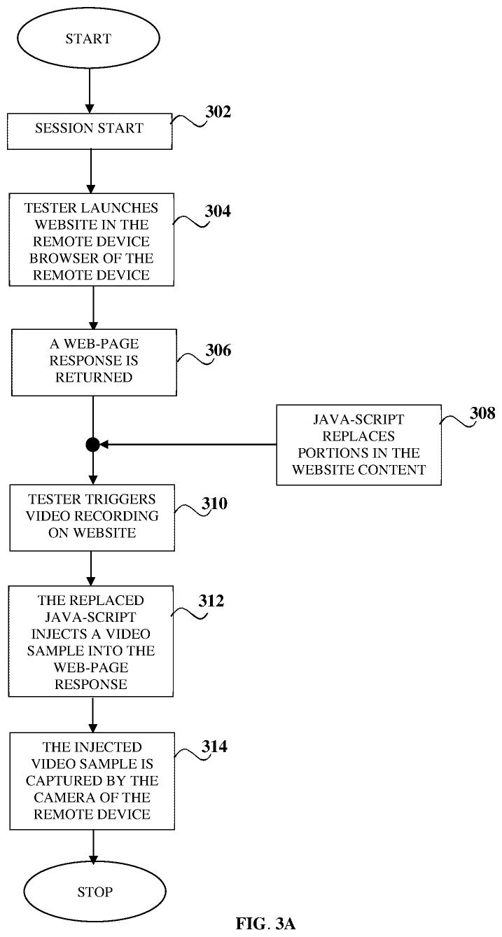

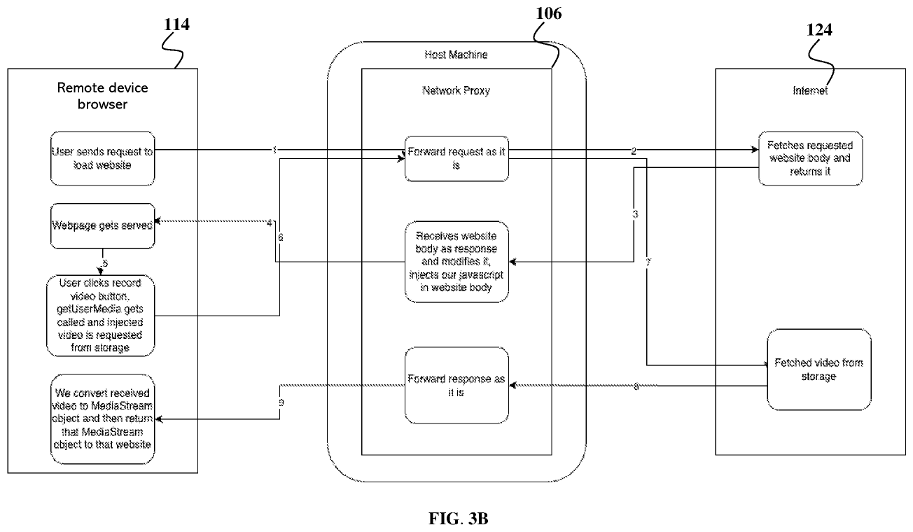

FIG. 3A exemplarily illustrates a flowchart associated with the method followed in the video injection system 100 to test websites across multiple remote devices, as an example embodiment of the present disclosure. At 302, a testing session is initiated. At 304, the tester launches website in the remote device's browser 114 of the remote device 104. At 306, a web-page response 118 is returned, which is intercepted by a proxy layer 106 at 308. At 308, an injected java-script 120 from the proxy layer 106 replaces portions in the website content or web-page response 118. At 310, the tester triggers video recording on the website. At 312, the replaced java-script 120 injects a video sample into the web-page response 118. At 314, the injected video sample is captured by the camera of the remote device 104.

The video injection system 100 provides solutions for different other problems that are faced in the remote testing process.

In an example, Problem 1: User's website has CORS and Content-Security-Policy enabled which lets only the media from the whitelisted domains to be played on the website under test. However, with test infrastructure platform, the media is also stored in a remote storage and the challenge is to allow playing this video without whitelisting the remote storage domain.

The solution to problem 1: The proxy layer 106 that modifies the web-page response 118 received by the remote device's browser 114 alters: 1) the Content-Security-Policies that are set in plurality of response headers to allow the injected java-script 120 to be loaded on the website; and 2) the Cross-origin resource sharing (CORS) policy that is set in the multiple response headers of the web-page response 118, to enable loading of the uploaded video samples from the storage platform 122 that is not whitelisted on the website under test.

In another example, Problem 2: While the video is streamed from a source, the media stream object can be created by browsers only. Also, there are loading/buffering related issues which spoil the experience or may even break the tests.

The solution to problem 2: The proxy layer 106 that modifies the web page response 118 received by the remote device's browser 114: 1) converts streaming of the uploaded video sample via the injected java-script 120 into a media stream object; 2) creates a video object from the streamed uploaded video sample, which is played into a canvas object; and 3) generates a media stream object from the canvas object.

FIG. 3B illustrates a block diagram of the modified website testing procedure using the video injection system 100, which tests a website across multiple remote devices, as an example embodiment of the present disclosure. With reference to FIG. 1 and FIG. 3B, in an embodiment, the modified website testing procedure using the video injection system 100 fundamentally involves the use of the remote device's browser 114, a network proxy 106, and an internet server or web server 124. In a step 1: a user (tester) uses the remote device's browser 114 to send a request to load a website to a host machine that contains the network proxy 106. In a step 2: the network proxy 106 forwards the request as it is from the remote device's browser 114 to the internet server 124, where the internet server 124 fetches the requested website body and returns the same.

In a step 3, the internet server 124 transmits the website body as a response, which is received by the network proxy 106. The network proxy 106 modifies the response and injects the java-script 120 in the website body. In a step 4, the webpage with the injected java-script 120 is served to the remote device's browser 114. In a step 5, using the remote device's browser 114, the tester clicks on the record video button, which calls the system method getUserMedia( ), which generates a request for a video sample from the storage platform 122 that needs to be injected into the web page response. In a step 6, the request for the stored video sample is sent to the network proxy 106, and in a step 7, the request for the stored video sample fetches the video sample from the storage platform 122. In a step 8, the web page response with the fetched and injected video sample is forwarded to the proxy layer 106, and in a step 9, the proxy layer 106 forwards the web page response as it is to the remote device's browser 114. Further in step 9, the received video is converted to a media-stream object, and then the media-stream object is returned to the website.

Example Implementation Mechanism—Hardware Overview: Some embodiments are implemented by a computer system or a network of computer systems. A computer system may include a processor, a memory, and a non-transitory computer-readable medium. The memory and non-transitory medium may store instructions for performing methods, steps and techniques described herein.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be server computers, cloud computing computers, desktop computer systems, portable computer systems, handheld devices, networking devices or any other device that incorporates hard-wired and/or program logic to implement the techniques.

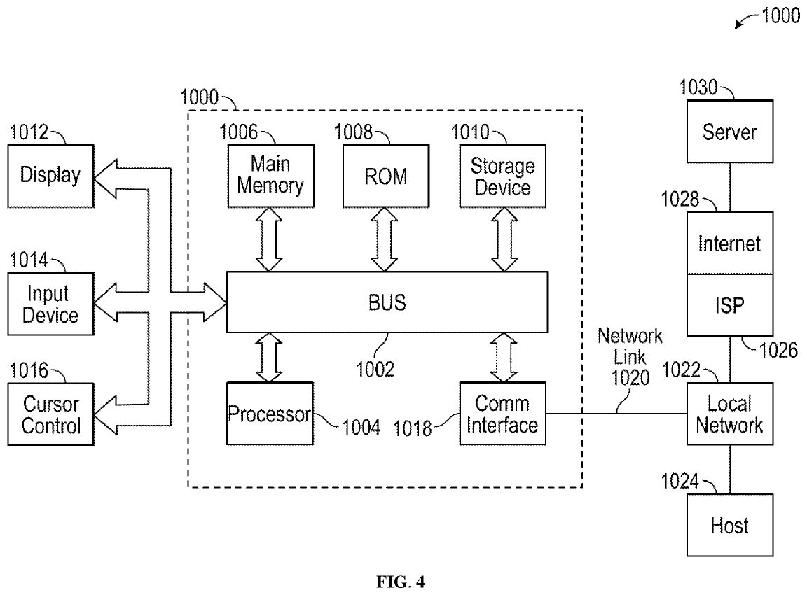

For example, FIG. 4 is a block diagram that illustrates a computer system 1000 upon which embodiments of the video injection system 100 can be implemented. Computer system 1000 includes a bus 1002 or other communication mechanism for communicating information, and a hardware processor 1004 coupled with bus 1002 for processing information. Hardware processor 1004 may be, for example, special-purpose microprocessor optimized for handling audio and video streams generated, transmitted, or received in video conferencing architectures.

Computer system 1000 also includes a main memory 1006, such as a random-access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid state disk is provided and coupled to bus 1002 for storing information and instructions. Computer system 1000 may be coupled via bus 1002 to a display 1012, such as a cathode ray tube (CRT), liquid crystal display (LCD), organic light-emitting diode (OLED), or a touchscreen for displaying information to a computer user. An input device 1014, including alphanumeric and other keys (e.g., in a touch screen display) is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some embodiments, the user input device 1014 and/or the cursor control 1016 can be implemented in the display 1012 for example, via a touch-screen interface that serves as both output display and input device.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical, magnetic, and/or solid-state disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, and/or stored in storage device 1010, or other non-volatile storage for later execution.

### EXAMPLES

It will be appreciated that the present disclosure may include any one and up to all of the following examples.

Example 1: A video injection system to test websites across a plurality of remote devices, wherein the video injection system comprising: a user browser installed on a user device that is controlled by at least one processor, wherein the user browser is used to log-in and connect to a cloud server that comprises representations of the plurality of remote devices, wherein the user browser is used to remotely connect to a remote device on the cloud server, and wherein the remote device uses a remote device's browser to access a website by performing a network call, which retrieves a web-page response associated with the website; and a proxy layer present in the cloud server intercepts the retrieved web-page response and injects a java-script into the retrieved web-page response, wherein when the user accesses a camera of the remote device via the remote device's browser, the injected java-script injects a video sample that was uploaded on a storage platform to the web page response, so that the injected video sample is captured by the camera of the remote device.

Example 2: The video injection system of example 1, wherein the cloud server assigns a remote device from the plurality of remote devices, wherein the cloud server streams the assigned remote device to the user browser so that the user is enabled to view an actual screen of the assigned remote device on the user browser.

Example 3: The video injection system of some or all of Examples 1 and 2, further comprising a plurality of video samples that are uploaded on the storage platform that is in communication with the cloud server, and wherein the injected java-script retrieves one of the uploaded video samples from the storage platform and injects the video sample on the remote device's browser when the user accesses the camera of the remote device.

Example 4: The video injection system of some or all of Example 1-3, wherein when the network call is made to load the website, the website sends the web-page response which contains web components associated with the website, and wherein when the web-page response reaches the proxy layer, the java-script is injected into the web-page response which becomes a part of the user's web-page source.

Example 5: The video injection system of some or all of Example 1-4, wherein once the website loads, and each time the camera is accessed, a call is made to a system function, which is intercepted by the injected java-script to stream one of the uploaded video samples instead of direct video stream from the camera of the remote device and supplies the stream to the website as output of the camera.

Example 6: The video injection system of some or all of Example 1-5, wherein the proxy layer that modifies the web page response received by the remote device's browser alters: the Content-Security-Policies that are set in plurality of response headers to allow the injected java-script to be loaded on the website; and the Cross-origin resource sharing (CORS) policy that is set in the multiple response headers of the web-page response, to enable loading of the uploaded video samples from the storage platform that is not whitelisted on the website under test.

Example 7: The video injection system of some or all of Example 1-6, wherein the proxy layer that modifies the web page response received by the remote device's browser: converts streaming of the uploaded video sample via the injected java-script into a media stream object; creates a video object from the streamed uploaded video sample, which is played into a canvas object; and generates a media stream object from the canvas object.

Example 8: A method to test websites across a plurality of remote devices, wherein the method comprising: providing a user browser installed on a user device that is controlled by at least one processor; logging in to a cloud server via the user browser, wherein the cloud server comprises representations of the plurality of remote devices; remotely connecting to a remote device on the cloud server using the user browser; accessing a website by performing a network call via a remote device's browser of the remote device, which retrieves a web-page response associated with the website; intercepting the retrieved web-page response via a proxy layer present in the cloud server; injecting a java-script into the retrieved web-page response via the proxy layer; injecting, via the injected java-script, a video sample that was uploaded on a storage platform to the web page response when the user accesses a camera of the remote device via the remote device's browser; and capturing the injected video sample via the camera of the remote device.

Example 9: The method of Examples 8, further comprising assigning the remote device via the cloud server from the plurality of remote devices, wherein the cloud server streams the assigned remote device to the user browser so that the user is enabled to view an actual screen of the assigned remote device on the user browser.

Example 10: The method of some or all of Examples 8 and 9, further comprising a plurality of video samples that are uploaded on the storage platform that is in communication with the cloud server, and wherein the injected java-script retrieves one of the uploaded video samples from the storage platform and injects the video sample on the remote device's browser when the user accesses the camera of the remote device.

Example 11: The method of some or all of Examples 8-10, wherein when the network call is made to load the website, the website sends the web-page response which contains web components associated with the website, and wherein when the web-page response reaches the proxy layer, the java-script is injected into the web-page response which becomes a part of the user' s web-page source.

Example 12: The method of some or all of Examples 8-11, wherein once the website loads, and each time the camera is accessed, a call is made to a system function, which is intercepted by the injected java-script to stream one of the uploaded video samples instead of direct video stream from the camera of the remote device and supplies the stream to the website as output of the camera.

Example 13: The method of some or all of Examples 8-12, wherein the proxy layer that modifies the web page response received by the remote device's browser alters: the Content-Security-Policies that are set in plurality of response headers to allow the injected java-script to be loaded on the website; and the Cross-origin resource sharing (CORS) policy that is set in the multiple response headers of the web-page response, to enable loading of the uploaded video samples from the storage platform that is not whitelisted on the website under test.

Example 14: The method of some or all of Examples 8-13, wherein the proxy layer that modifies the web page response received by the remote device's browser: converts streaming of the uploaded video sample via the injected java-script into a media stream object; creates a video object from the streamed uploaded video sample, which is played into a canvas object; and generates a media stream object from the canvas object.

Example 15: A non-transitory computer storage that stores executable program instructions that, when executed by one or more computing devices, configure the one or more computing devices to perform operations comprising: logging in to a cloud server via the user browser that is installed on a user device that is controlled by at least one processor, wherein the cloud server comprises representations of the plurality of remote devices; remotely connecting to a remote device on the cloud server using the user browser; accessing a website by performing a network call via a remote device's browser of the remote device, which retrieves a web-page response associated with the website; intercepting the retrieved web-page response via a proxy layer present in the cloud server; injecting a java-script into the retrieved web-page response via the proxy layer; injecting, via the injected java-script, a video sample that was uploaded on a storage platform to the web page response when the user accesses a camera of the remote device via the remote device's browser; and capturing the injected video sample via the camera of the remote device.

It will be understood that each block of the block diagrams can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the drawings and specification, there have been disclosed exemplary embodiments of the invention. Although specific terms are employed, they are used in a generic and descriptive sense only and not for purposes of limitation of the scope of the invention.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

We claim:

1. A video injection system to test websites across a plurality of remote devices, wherein the video injection system comprising:
a user browser installed on a user device that is controlled by at least one processor, wherein the user browser is used to log-in and connect to a cloud server that comprises representations of the plurality of remote devices,
wherein the user browser is used to remotely connect to a remote device on the cloud server,
and wherein the remote device uses a remote device's browser to access a website by performing a network call, which retrieves a web-page response associated with the website; and
a proxy layer present in the cloud server intercepts the retrieved web-page response and injects a java-script into the retrieved web-page response,
wherein when the user accesses a camera of the remote device via the remote device's browser, the injected java-script injects a video sample that was uploaded on a storage platform to the web page response, so that the injected video sample is captured by the camera of the remote device.

2. The video injection system as claimed in claim 1, wherein the cloud server assigns a remote device from the plurality of remote devices, wherein the cloud server streams the assigned remote device to the user browser so that the user is enabled to view an actual screen of the assigned remote device on the user browser.

3. The video injection system as claimed in claim 1, further comprising a plurality of video samples that are uploaded on the storage platform that is in communication with the cloud server, and wherein the injected java-script retrieves one of the uploaded video samples from the storage platform and injects the video sample on the remote device's browser when the user accesses the camera of the remote device.

4. The video injection system as claimed in claim 1, wherein when the network call is made to load the website, the website sends the web-page response which contains web components associated with the website, and wherein when the web-page response reaches the proxy layer, the java-script is injected into the web-page response which becomes a part of the user's web-page source.

5. The video injection system as claimed in claim 4, wherein once the website loads, and each time the camera is accessed, a call is made to a system function, which is intercepted by the injected java-script to stream one of the uploaded video samples instead of direct video stream from the camera of the remote device and supplies the stream to the website as output of the camera.

6. The video injection system as claimed in claim 1, wherein the proxy layer that modifies the web page response received by the remote device's browser alters:
the Content-Security-Policies that are set in plurality of response headers to allow the injected java-script to be loaded on the website; and
the Cross-origin resource sharing (CORS) policy that is set in the multiple response headers of the web-page response, to enable loading of the uploaded video samples from the storage platform that is not whitelisted on the website under test.

7. The video injection system as claimed in claim 1, wherein the proxy layer that modifies the web page response received by the remote device's browser:
converts streaming of the uploaded video sample via the injected java-script into a media stream object;
creates a video object from the streamed uploaded video sample, which is played into a canvas object; and
generates a media stream object from the canvas object.

8. A method to test websites across a plurality of remote devices, wherein the method comprising:
providing a user browser installed on a user device that is controlled by at least one processor;
logging in to a cloud server via the user browser, wherein the cloud server comprises representations of the plurality of remote devices;
remotely connecting to a remote device on the cloud server using the user browser;
accessing a website by performing a network call via a remote device's browser of the remote device, which retrieves a web-page response associated with the website;
intercepting the retrieved web-page response via a proxy layer present in the cloud server;
injecting a java-script into the retrieved web-page response via the proxy layer;
injecting, via the injected java-script, a video sample that was uploaded on a storage platform to the web page response when the user accesses a camera of the remote device via the remote device's browser; and
capturing the injected video sample via the camera of the remote device.

9. The method as claimed in claim 8, further comprising assigning the remote device via the cloud server from the plurality of remote devices, wherein the cloud server streams the assigned remote device to the user browser so that the user is enabled to view an actual screen of the assigned remote device on the user browser.

10. The method as claimed in claim 8, further comprising a plurality of video samples that are uploaded on the storage platform that is in communication with the cloud server, and wherein the injected java-script retrieves one of the uploaded video samples from the storage platform and injects the video sample on the remote device's browser when the user accesses the camera of the remote device.

11. The method as claimed in claim 8, wherein when the network call is made to load the website, the website sends the web-page response which contains web components associated with the website, and wherein when the web-page response reaches the proxy layer, the java-script is injected into the web-page response which becomes a part of the user's web-page source.

12. The method as claimed in claim 8, wherein once the website loads, and each time the camera is accessed, a call is made to a system function, which is intercepted by the injected java-script to stream one of the uploaded video samples instead of direct video stream from the camera of the remote device and supplies the stream to the website as output of the camera.

13. The method as claimed in claim 8, wherein the proxy layer that modifies the web page response received by the remote device's browser alters:
the Content-Security-Policies that are set in plurality of response headers to allow the injected java-script to be loaded on the website; and
the Cross-origin resource sharing (CORS) policy that is set in the multiple response headers of the web-page response, to enable loading of the uploaded video samples from the storage platform that is not whitelisted on the website under test.

14. The method as claimed in claim 8, wherein the proxy layer that modifies the web page response received by the remote device's browser:
converts streaming of the uploaded video sample via the injected java-script into a media stream object;
creates a video object from the streamed uploaded video sample, which is played into a canvas object; and
generates a media stream object from the canvas object.

15. A non-transitory computer storage that stores executable program instructions that, when executed by one or more computing devices, configure the one or more computing devices to perform operations comprising:
logging in to a cloud server via the user browser that is installed on a user device that is controlled by at least one processor, wherein the cloud server comprises representations of the plurality of remote devices;
remotely connecting to a remote device on the cloud server using the user browser;
accessing a website by performing a network call via a remote device's browser of the remote device, which retrieves a web-page response associated with the website;
intercepting the retrieved web-page response via a proxy layer present in the cloud server;
injecting a java-script into the retrieved web-page response via the proxy layer;
injecting, via the injected java-script, a video sample that was uploaded on a storage platform to the web page response when the user accesses a camera of the remote device via the remote device's browser; and
capturing the injected video sample via the camera of the remote device.
